(19) United States
(12) Patent Application Publication
(10) Pub. No.: US 2017/0357275 A1
(43) Pub. Date: Dec. 14, 2017

(54) WIRELESS SYSTEM FOR PROTECTING BUILDINGS AGAINST WATER LEAKS

(71) Applicant: Joshua Mark Smith, New York, NY (US)

(72) Inventor: Joshua Mark Smith, New York, NY (US)

(21) Appl. No.: 15/618,119

(22) Filed: Jun. 8, 2017

Related U.S. Application Data
(60) Provisional application No. 62/347,462, filed on Jun. 8, 2016.

(51) Int. Cl. G05D 7/06; H04L 29/08; F16K 17/36; G08B 21/20

(52) U.S. Cl. CPC G05D 7/0635; G08B 21/20; H04L 67/26; F16K 17/36

(57) ABSTRACT

A water leak detection and prevention system employs water flow, moisture and temperature sensors within a monitored residential, commercial or industrial building. A motor-actuated valve has been installed that controls water flow through the main water pipe or branch pipe. A flow sensor is used to detect water flow through a building's main or branch water pipe. Moisture sensors and temperature sensors are placed at strategic locations throughout the monitored building. All sensors communicate wirelessly with a gateway. A signal is sent to the gateway whenever a sensor detects a dangerous condition. Signals are relayed from the gateway to a server that manages the system. Alerts are sent to building personnel via push notification and phone calls. Any of such personnel can transmit a command to the server, which is relayed to the affected gateway, which sends a wireless signal to shut off the motor-actuated valve.

### BACKGROUND OF THE INVENTION

### 1. Field of the Invention

The present invention relates, generally, to water leak detection and prevention systems and, more particularly, to systems that employ various types of sensors to continuously monitor a building for conditions that promote water leaks, for actual water leaks and which provides property managers with means to remotely cut off water flow in the building.

### 2. History of the Prior Art

Water leakage and flooding are the most significant causes of economic loss to building owners and to building occupiers. Economic losses to fire pale in comparison to losses from water leakage and flooding. In cold climates, inadequate insulation and periods of extreme cold can cause pipes to rupture and flood the interior of buildings. Electrolysis and corrosion can also play a part in the failure of metal water pipes.

Undetected water leaks in residential and commercial buildings can lead to extensive water damage to not only the contents of the building, but to the building structure as well. The cost of repairing the damage can pale in comparison to the losses associated with non-use of the building while the repairs are being made. Though property owners and businesses typically insure themselves against losses associated with water leaks, the sky rocketing costs of insurance premiums deductibles mandates that damage from water leaks be minimized by prompt action to cut off the water supply as quickly as possible once a leak occurs or when conditions exist that make leaks likely.

When buildings are occupied, the likelihood of extensive damage occurring is greatly reduced. However, many buildings are occupied only part time. Office and commercial buildings are typically occupied only during normal working hours, or nine out of every 24 hours on work days. During weekends, the unoccupied time can last up to 63 hours. If a holiday falls on a Friday or Monday, unoccupied time can extend to nearly 90 hours. During such a period, the potential for extensive damage is far greater. Undetected water leaks can quickly flow through the walls, floors or ceilings of unoccupied areas and seep into adjacent areas, resulting is damage to large portions of a building.

Flooding of buildings is particularly costly for several reasons. Wood flooring is almost always destroyed by flooding, as it swells with moisture, which can cause buckling of the floor. If floor does not buckle, the individual boards shrink after swelling, leaving large gaps between the boards. Because it is difficult to dry quickly and mold soon begins to grow on the backing material, carpet is also usually destroyed by flooding. Gypsum board wall sheeting is always destroyed in floods because black mold begins to grow within 48 hours on the paper backing, which has a high-cellulose content. Structural damage to the building structure can also occur. This is particularly true if the moisture is not removed within a very short period of time. Termites are attracted to moist wood structures, and wood rot will, over time, destroy the structural integrity of wood structural elements. Because many walls are hollow, it may not be possible to adequately dry those spaces without tearing out plaster and sheet rock. Severe health hazards may result if mold begins to grow in the presence of moisture.

Rather than attempt to repair the damage caused by broken pipes, it makes far more sense to prevent the occurrence of the damage. Although it is impossible to prevent all water leaks in buildings, if the water to a building can be shut off very quickly after a leak occurs, a majority of the damage can be prevented.

A number of water leak detection devices have been implemented to address the quick response time needed to detect water leaks. Some prior art devices include localized leak detection devices that are situated throughout various locations within a building to alert the presence of water. Such devices typically include a small housing enclosing both a water sensor and audible alarm.

U.S. Pat. No. 6,453,247 to Osama Hunaidi discloses a method for detecting leaks in plastic water distribution pipes by processing the sound or vibration induced in the pipe by water escaping under pressure. Acoustic leak signals are measured at two or more contact points within the pipe. The signals are digitally recorded using a computer's sound card. The leak is located using the difference in arrival times of two leak signals as determined from the cross-correlation function.

U.S. Pat. Nos. 7,306,008 and 7,900,647 to Paul G. Tornay disclose a water leak detection and prevention system in which water is only delivered to the water pipes in the building when a faucet or appliance demands water, and water is delivered through a normally-closed water shut-off valve.

U.S. Pat. No. 7,360,413 to William Worthington Jeffries, et al. Discloses a wireless water flow monitoring and leak detection system that includes a base station, a memory, and a central processing unit configured to control the operation of the system and to analyze stored data. A plurality of highly-sensitive wireless flow sensor nodes are each installed individually on a supply line of a water fixture in a facility having a plurality of water fixtures. The wireless flow sensor nodes can periodically read and store a data point corresponding to either a flow condition or a no flow condition occurring at the water fixture. A plurality of coordinator nodes are configured to wirelessly relay data between the plurality of wireless flow sensor nodes and the base station. The base station is configured to determine, based on an analysis of the stream of data points, whether a leak exists in any of the water fixtures. If a leak is determined to exist, a maintenance alert is generated.

U.S. Pat. No. 8,749,393 to Robin Tollefson discloses as method and apparatus for detecting leakage of flowing liquids from pipes, including an upstream flow-rate sensor positioned between a source of a flowing liquid which is conducted from a source to a destination terminal, such as a VAV heat exchanger, and a downstream flow-rate sensor positioned between an outlet port of the destination terminal and a return line for the flowing liquid. The apparatus includes electronic control circuitry which is responsive to a differential flow rate between upstream and downstream measured flow rates which exceeds a predetermined limit value in removing a valve-opening signal to the upstream shut-off valve, thus closing the valve to interrupt flow of liquid through the valve if the differential flow rate signifies a leak.

U.S. Pat. No. 8,922,379 to John Meyer discloses a centralized water leak detection system for detecting water leaks in residential and commercial buildings. The water leak detection system provides central station monitoring and point identification data of water leaks. The centralized water detection system includes a plurality of address modules connected to a plurality of sensors for assigning an identifier to each sensor. The address modules are connected to a central control for processing detected sensor signals. A water alarm annunciator is remotely installed in a central monitoring station for displaying point identification data showing detection and location of water leaks.

What is still needed is a system that will not only detect leaks, but also environmental conditions that are likely to cause leaks, send signals representative of those conditions to a gateway unit that can receive signals from multiple buildings, transfer those signals to a server that can send alerts to multiple individuals associated with the care of a particular building and enable any of those individuals to shut off the supply of water to the affected building.

### SUMMARY OF THE INVENTION

The present invention provides a water leak prevention and detection system that employs water flow, moisture and temperature sensors within a monitored residential, commercial or industrial building, in which a motor-actuated valve has been installed that controls water flow through the building's main water pipe or to each of multiple branch pipes in a larger building. A flow sensor just downstream of the motor-actuated valve is used to detect water flow through the motor-actuated valve. Moisture sensors and temperature sensors are also placed at strategic locations throughout the building. All sensors within a monitored building communicate wirelessly at a frequency of 900 MHZ with a gateway unit in that building. Range extenders can be used to improve reception from distant sensors. The gateway unit communicates with a server computer system via either an ethernet connection or a cellular phone network, such as Verizon® Wireless. Because of cellular tower redundancy in city locations, cellular phone networks tend to be extremely reliable. The server computer system hosts a computer program that manages the leak prevention, detection and control system. Each wireless sensor signal includes a unique identification code that enables the leak prevention, detection and control system to identify the physical location of that sensor. A signal is sent to the gateway unit whenever a flow sensor detects water flow in the main pipe, whenever moisture is detected within the building, or whenever a temperature sensor detects a temperature below a set level (e.g., 50 degrees Fahrenheit or 10 degrees Celsius). The temperature setting can be adjusted to suit the requirements of the monitoring system. From the gateway unit, signals are relayed to the server computer system. When the server receives a water flow signal, a low temperature signal or a moisture (i.e., leak) signal from a gateway, a push notification and a phone call is sent to all management personnel associated with the affected building who are identified by the programming of the leak prevention, detection and control system. A downloadable smart phone application enables any one of those personnel to communicate with the leak prevention, detection, and control system, and have a control signal sent to the affected gateway unit, which will shut off water flow in the area where one or more of the following conditions have been detected by a sensor: water flow indicative of a leak, an actual leak, or a potentially dangerous temperature drop. The leak prevention, detection, and control system can be programmed, via the smart phone application, to ignore flow sensor alerts which are not indicative of the existence of a leak condition. For example, during known periods of occupancy, flow sensor signals sent during those times would be ignored. Of course, if a leak has in fact been detected by the presence of water or moisture, an alert would be sent to building management personnel regardless of the occupancy programming. has been detected.

### BRIEF DESCRIPTION OF THE DRAWINGS

FIG. 1 is a basic system diagram, showing multiple protected buildings; and

FIG. 2 is a cross-sectional view of a single six-story building with a basement having a plurality of temperature sensors, moisture sensors, a whole-building water flow sensor, a cellular gateway, and a motor-actuated shut-off valve for the entire building.

### DETAILED DESCRIPTION OF THE PREFERRED EMBODIMENT

The invention will now be described with reference to the attached drawing figures. It should be understood that the drawings are not necessarily drawn to scale and are intended to be merely illustrative of the invention.

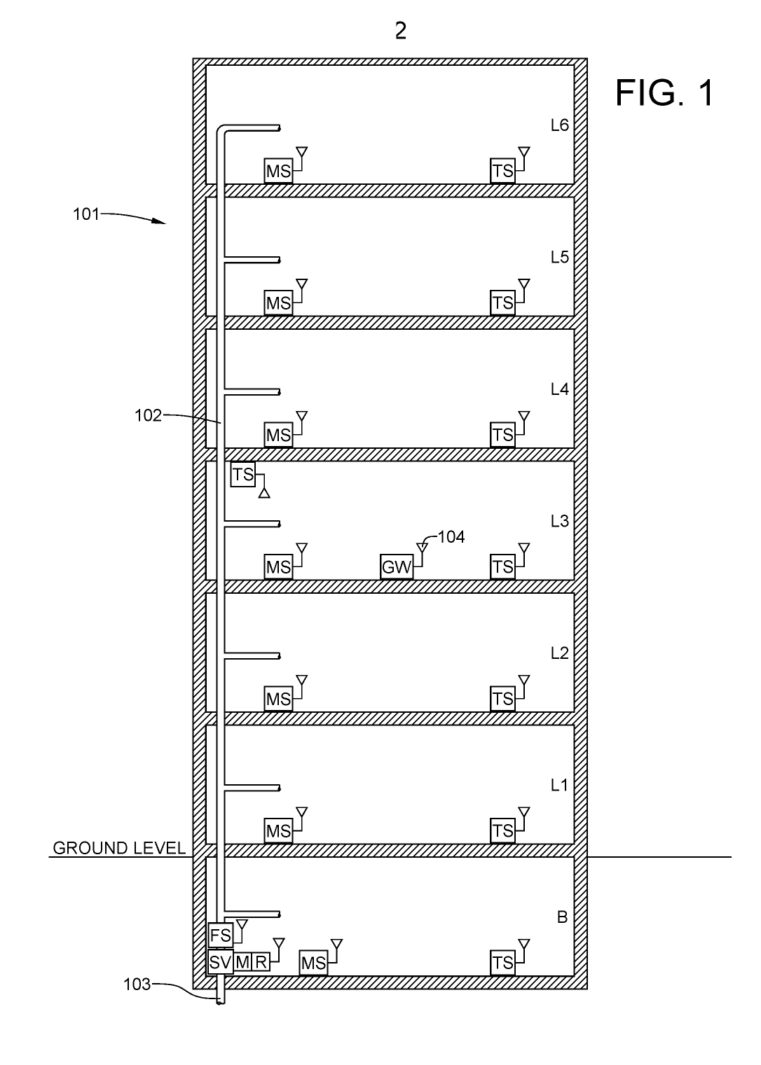

Referring now to FIG. 1, this cross-sectional view of a six-story commercial or residential building 101 having a basement shows at least one temperature sensor (TS) installed on each floor L1, L2, L3, L4, L5, L6, including the basement B. In addition, at least one moisture sensor (MS) is installed on each floor, including the basement. A branching water distribution pipe network 102 enters the building through a water service entrance pipe 103 in the basement level B. The service entrance pipe 103 passes through a shut-off valve SV having a electrical motor actuator M connected thereto. Before entering the branching water distribution pipe network 102, the service entrance pipe 103 also passes through a water flow sensor FS. Each temperature sensor TS, each moisture sensor MS, and the water flow sensor FS incorporates a radio transmitter by means of which alerts can be sent to a gateway unit GW. The gateway unit GW has a transceiver antenna 104. The gateway unit GW can receive sensor signals from the temperature sensors TS, from the moisture sensors MS, and from the flow sensor FS. Likewise signals can be sent from the gateway unit GW to a relay R that controls the motor M, which opens or closes the shut-off valve SV. The relay R incorporates a radio receiver and an antenna that enable the shut-off valve motor M to receive water shut-off or turn-on commands sent from the hosted server 204 to the gateway GW located within the building. The shut-off valve motor M is preferably powered by an AC-to-DC power supply. A battery backup power source may be provided as an option. When building management personnel receive push notification and telephone call alerts that indicate either the presence of a leak or of a potentially dangerous low-temperature condition, any of them can access the leak prevention and detection system program running on the hosted server 104 via a smart phone application. The system will continue to send alerts to building management personnel until one of them sends a command to the hosted server 104 that will be sent to the gateway GW of the affected building 101 that will, then, be transmitted to the radio receiver that controls the shut-off valve motor relay R, and the shut-off valve SV will be closed, thereby eliminating the threat and preventing or minimizing the water damage.

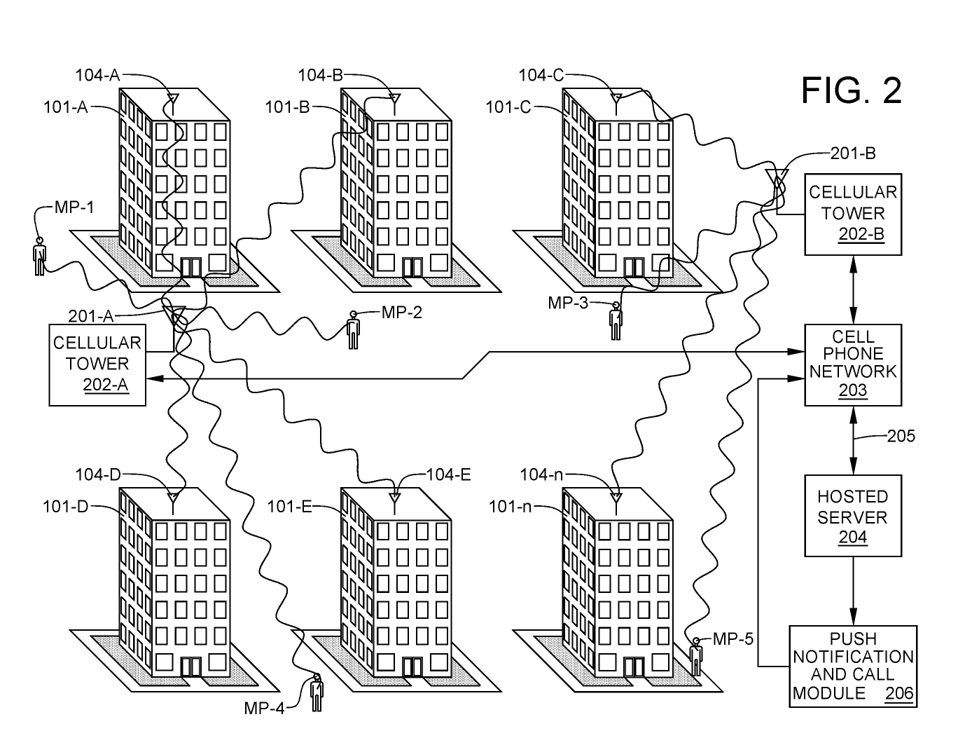

Referring now to FIG. 2, multiple commercial or residential buildings 101-A (also known as 10 Alpha Street), 101-B (also known as 20 Broad Street), 101-C (also known as 30 Canal Street), 101-D (also known as 40 Dey Street, 101-E (also known as 50 Erie Street) and 101-n, have different owners, but are managed by the ABC Management Company, which provides a service for the prevention and detection of internal water leaks. Although each building is shown as having an external radio antenna 104-A, 104-B, 104-C, 104-D, 104-E and 104-n, this is merely representative of a radio transceiver antenna that is incorporated into the cellular gateway unit GW present in each building. Each gateway GW is preferably installed in a central location of its associated building so that it is within range of signals sent by each sensor that is part of the leak prevention and detection system. Range extenders can be employed to relay signals from sensors which are too distant from the gateway unit. Each cellular gateway unit GW can communicate with the antennae 201-A and 201-B on one of several local cellular towers, such as 202-A or 202-B, respectively. Each radio transmitter associated with a sensor transmits a signal packet that contains sensor data as well as an ID code, which enables the location of that sensor to be identified. The local cellular towers 202-A and 202-B are portals to a cellular phone network 203, such as Verizon® Wireless. The cellular network 203 provides connection to a hosted server 204 via an Internet connection 205. As an alternative, connection to the Internet-hosted server 204 can also be made through a wired Ethernet gateway or a fiber optic network gateway (neither of which are shown). Wireless cellular networks are preferred to a wired or fiber optic connections because of cellular tower redundancy that is especially prevalent in metropolitan areas. Bidirectional communication between the cellular gateway and the hosted server 204 is established through the cellular phone network 203. All signals received by a building's cellular gateway GW are transferred to the hosted server 204 via the cell phone network 203. The hosted server 204 runs a computer program that manages the water leak prevention and detection system. Sensor signals—which identify a potentially dangerous condition existing at one of the protected buildings—are received and processed by the hosted server 204. As previously noted, there are three types of sensors within each building: temperature sensors TW, moisture sensors MS, and a water flow sensor FS. An alert is sent to the cellular gateway GW whenever a temperature sensor detects a temperature below a set level (e.g., 50 degrees Fahrenheit or 10 degrees Celsius). The temperature setting can be adjusted to suit the requirements of the monitoring system. An interior temperature lower than 50 degrees Fahrenheit can be indicative of a failure of the affected building's heating system, a failure to correctly set the building's heating thermostat, or simply inability of the building's heating system to keep up with heat losses to the exterior during a period of unusual cold. Exterior temperatures in the area can also be monitored. An outside temperature signal is sent to the hosted server 105 whenever an outside temperature sensor senses a drop to 39 degrees Fahrenheit. As temperature drops by additional one-degree increments, each lower value is also sent to the hosted server 204. If the interior temperature of a monitored building is lower than 50 degrees Fahrenheit and the outside temperature has reached 39 degrees Fahrenheit and is falling, a push notification and a phone call, featuring a computerized voice alert that tells the individual to check his smart phone, is sent to each of the personnel who are responsible for management of the affected building. Thus, the system need not rely on a single individual for the monitoring of buildings. Any authorized individual having a smart phone can download the smart phone application from either the hosted server or from an application download site. In order to provide the greatest amount of functionality, both iOS and Android smart phones are supported. The application can be activated by a code assigned to the individual that is known to the hosted server. If a moisture sensor alert is received by the hosted server 204, a leakage condition in the affected building almost certainly exists. Thus, push notifications and phone calls are automatically sent to the building management personnel MP-1, MP-2, MP-3, MP-4 and MP-5 who are responsible for the affected building. The affected building is identified in the push notification by its address (e.g., 30 Canal Street). If the water flow sensor in one of the buildings detects that water is suddenly flowing in the main service entrance conduit, an alert is sent to the hosted server 204. The system program running on the hosted server can be programmed to specify periods of building occupancy. For example, if the building is normally occupied on workdays from 8:00 a.m. to 5:00 p.m., and an alert is received by the hosted server 204 during that period of a workday, the alert is ignored. However, if the alert is received after working hours or during a weekend or holiday, push notifications and phone calls are sent to all building management personnel.

Wireless sensors are manufactured by many suppliers. One such supplier is Monnit Corporation, which has its headquarters at 4403 South 500 West in Murray, Utah 84123. Monnit supplies over 60 different types of wireless sensors, including water detection sensors and temperature sensors. One or more range extenders can be employed to transmit the wireless signal to the base station 103.

Both mechanical and electronic flow sensors can be used to implement the present invention. A preferred electronic water flow sensor has been developed for the present application that uses a piezoelectric sensor. The piezoelectric sensor is attached via an adhesive to the main entrance water pipe, and the piezoelectric sensor is coupled to a custom-built signal amplification operational amplifier circuit. The piezoelectric sensor creates an electrical signal based on the vibrations of the water main pipe, and this signal is amplified to an appropriate magnitude by the amplification circuit. The signal of the amplification circuit is continuously monitored by a microprocessor, which continuously sends a signal to the base station 103 via a Monnit wireless transmitter.

For a pipe of a given diameter, a fundamental resonant frequency will be produced by water flow therein. With a linear based interpretation, this vibration yields an absolute impulse at a frequency that is only barely above the average frequency of ambient noise.

A piezoelectric disc sensor is adhesively attached to a water pipe in which water flow is to be monitored. A vibration within the water pipe causes the piezoelectric sensor to produce a signal voltage across its terminals. The signal is first conditioned, then filtered to achieve a greater signal-to-noise ratio, and finally amplified, smoothed and analyzed then passed thrA separate piezoelectric conditioning circuit is specially tuned to separate the very small vibration signal from ambient electrical noise. To achieve greater signal-to-noise ratio, the piezo conditioning circuit first passes the piezo signal through a high-pass filter. The filtered signal is then amplified, smoothed, and analyzed.

In order to provide a cost-effective solution for the computational requirements of signal analysis, a single-board, microcontroller-based computer having standardized input-output interfaces is employed. The microcontroller, which employs reduced instruction set computation (RISC), is pre-programmed with a boot loader that simplifies uploading of programs to the on-chip flash memory. One such microcontroller-based computer that meets these requirements is the Raspberry Pi series Version 3 microcomputer, an open-source microcontroller board design, produced by several vendors, using various microcontrollers, that can be used to build digital devices and interactive objects that can sense and control physical devices. These open-source systems are programmed with open-source software, which includes support for the C and C++ programming languages, and provide sets of digital and analog I/O pins that can interface to various expansion boards, called “shields”, and to other circuits.

The United Kingdom's Raspberry Pi Foundation created the low-cost Raspberry Pi on order to combat the declining numbers and skills of applied computer science students. The first Raspberry Pi was introduced in 2012 for the purpose of inspiring technological innovation as quickly as possible.

Electric-motor-actuated valves are available from a number of domestic and international suppliers. One such valve is the Valworx 565208 electric-motor-actuated two-piece stainless steel ball valve that is manufactured in the U.S. by Valworx, Inc., which has its headquarters at 18636 Northline Drive, Cornelius, N.C. 28031. It can be used for on-off control of water, air, oil, and other liquids that are compatible with the materials of construction. The standard unit configuration is power-to-open and power to close. With loss of power, the valve retains its current position. On receipt of a continuous voltage signal, the electric motor runs and, via a self-locking gear drive, rotates the ball of the valve. The motor is stopped by internal cams striking limit switches. On receipt of a reversing continuous signal, the motor turns in the opposite direction reversing the valve position.

Although only a single embodiment of the wireless system for protecting buildings against water leaks has been shown and described, it will be obvious to those having ordinary skill in the art that changes and modifications may be made thereto without departing from the scope and the spirit of the invention as hereinafter claimed.

What is claimed is:

1. A water leak detection and prevention system for buildings comprises:
at least one water flow sensor, at least one moisture sensor, and at least one temperature sensor positioned on each floor of a multi-story building;
a radio transmitter for each sensor which transmits a signal packet containing not only data for its associated sensor, but also an ID code which identifies a location for the associated sensor;
a gateway within range of each of the radio transmitters, said gateway having a transceiver that can not only receive signal packets from the radio transmitters, but also send command signals;
a motor-controlled water shut-off valve for each floor of the building, said shut-off valve being openable and closeable in response to signals received from the gateway;
controlled by signals received from the gateway
a hosted computer server system that manages a water leak prevention and detection system, said server system accessible via the Internet; and
a telecommunications link between the gateway and the hosted computer server system;
wherein whenever the hosted computer server system receives notice from the gateway of a dangerous condition involving either a water leak or a high likelihood of a water leak within the building, a push notification text message and a phone call, featuring a computerized voice alert that tells the individual to check his smart phone, are sent to multiple persons who are responsible for management of the affected building so that any one of them can react to ameliorate the dangerous condition by having a signal sent to the shut-off valve on the affected floor.

2. The water leak detection and prevention system of claim 1, wherein said telecommunications link is a cellular telephone network.

3. The water leak detection and prevention system of claim 2, wherein said gateway is within range of multiple cellular antenna towers in order to provide redundancy for the leak detection and prevention system.

4.
